(19) United States
(12) Patent Application Publication
(10) Pub. No.: US 2025/0367713 A1
(43) Pub. Date: Dec. 4, 2025

(54) APPARATUS AND METHOD FOR CLEANING CANNABINOID INSTRUMENTS

(71) Applicant: Cannabis Solutions, Painesville, OH (US)

(72) Inventors: Michael ROSENBAUM, Beachwood, OH (US); Adam KLAVINGER, Richmond Heights, OH (US)

(73) Assignee: Cannabis Solutions, Painesville, OH (US)

(21) Appl. No.: 18/678,157

(22) Filed: May 30, 2024

(51) Int. Cl. B08B 3/14; B01D 3/14; B08B 3/08

(52) U.S. Cl. CPC B08B 3/14; B01D 3/14; B08B 3/08

(57) ABSTRACT

A cleaning apparatus for a cannabinoid instrument includes a lower receptacle defining a lower cavity for receiving a cleaning liquid; an upper receptacle arranged above the lower receptacle and defining an upper cavity for receiving the cannabinoid instrument, the upper cavity being in fluid communication with the lower cavity; and a heating system configured for vaporizing an amount of the cleaning liquid when the cleaning liquid is received in the lower cavity of the lower receptacle, such that the amount transforms to a cleaning vapor that rises into the upper cavity of the upper receptacle.

### FIELD OF THE INVENTION

The present disclosure relates to an apparatus and method for cleaning cannabinoid instruments and more particularly, an apparatus and method for cleaning cannabinoid instruments using a vaporized cleaning liquid.

### BACKGROUND

Cannabis distillate is a highly-concentrated cannabis oil that is useful in a wide variety of cannabis products. Briefly, the process of producing cannabis distillate begins with extracting a crude cannabis oil containing desirable cannabinoids (e.g., CBD and THC) from cannabis plant matter. Next, the crude oil may be winterized, where the oil is mixed with ethanol at low temperatures, which separates out fats and waxes. Finally, a distillation process is carried out where the crude oil product is evaporated and condensed, further purifying the oil. This process is often repeated multiple times until a desired purity is reached.

Various instruments (e.g., containers, utensils, tubing, etc.) are used to contain, convey, manipulate, or otherwise handle cannabinoid matter produced throughout the process above. Due to its high viscosity, the cannabinoid matter may stick to the surfaces of the instruments. Preferably, such cannabinoid matter should be removed before later uses of the instruments. However, conventional methods of cleaning the instruments such as hand washing are inefficient. Furthermore, the cannabinoid matter removed by conventional methods is often wasted.

### BRIEF SUMMARY

According to a first aspect, a cleaning apparatus for a cannabinoid instrument includes a lower receptacle defining a lower cavity for receiving a cleaning liquid; an upper receptacle arranged above the lower receptacle and defining an upper cavity for receiving the cannabinoid instrument, the upper cavity being in fluid communication with the lower cavity; and a heating system configured for vaporizing an amount of the cleaning liquid when the cleaning liquid is received in the lower cavity of the lower receptacle, such that the amount transforms to a cleaning vapor that rises into the upper cavity of the upper receptacle.

### BRIEF DESCRIPTION OF THE DRAWINGS

FIG. 1 schematically illustrates an example cleaning apparatus;

FIG. 2 is a schematic partial cross-section view of an upper receptacle of the cleaning apparatus;

FIG. 3 is a schematic top view of the upper receptacle, wherein a door of the upper receptacle is removed;

FIG. 4 is a schematic view of a lower receptacle of the cleaning apparatus; and

FIG. 5 is a schematic partial cross-section view of a heating system of the cleaning apparatus with the lower receptacle.

### DETAILED DESCRIPTION

The present disclosure relates to an apparatus and method for removing cannabinoid matter from instruments used in the production and/or distillation of cannabis oil. Further advantages will become apparent throughout the disclosure. Additionally, it should be understood that the teachings disclosed herein are not limited to a specific embodiment and that features discussed in certain embodiments may be combined, altered, or removed.

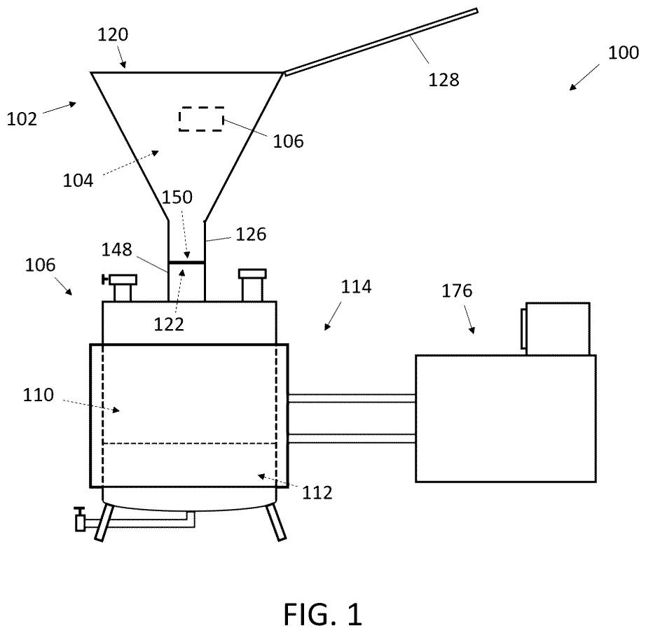

Turning to FIG. 1, an example cleaning apparatus 100 comprises an upper receptacle 102 defining an upper cavity 104 for receiving one or more cannabinoid instruments 106, a lower receptacle 108 defining a lower cavity 110 for receiving a cleaning liquid 112, and a heating system 114 that is operable to heat the cleaning liquid 112 within the lower cavity 110. Each cannabinoid instrument 106 can be any instrument (e.g., container, utensil, tubing, etc.) that is used to contain, convey, manipulate, or otherwise handle cannabinoid matter in the production and/or distillation of cannabis oil, particularly wherein cannabinoid matter adheres to a surface of the instrument. Moreover, the cleaning liquid 112 preferably comprises a liquid that is miscible with cannabinoid matter and can be used to remove such matter from surfaces of the instruments 106. The cleaning liquid 112 in the present example comprises alcohol, although other liquids (e.g., water, hexane, pentane, methanol, acetone, etc.) may be used without departing from the scope of the disclosure.

As discussed below in further detail, the heating system 114 can be operated to heat the cleaning liquid 112 within the lower cavity 110 and produce vapors that rise into the upper cavity 104. The vapors can then condense onto the instruments 106, such that the condensate mixes with the cannabinoid matter on surfaces of the instruments 106. The mixture then falls into the lower cavity 110 and combines with any residual cleaning liquid 112 and/or additional condensate to form a final solution that can be drained from the lower receptacle 108 and distilled to produce cannabis distillate.

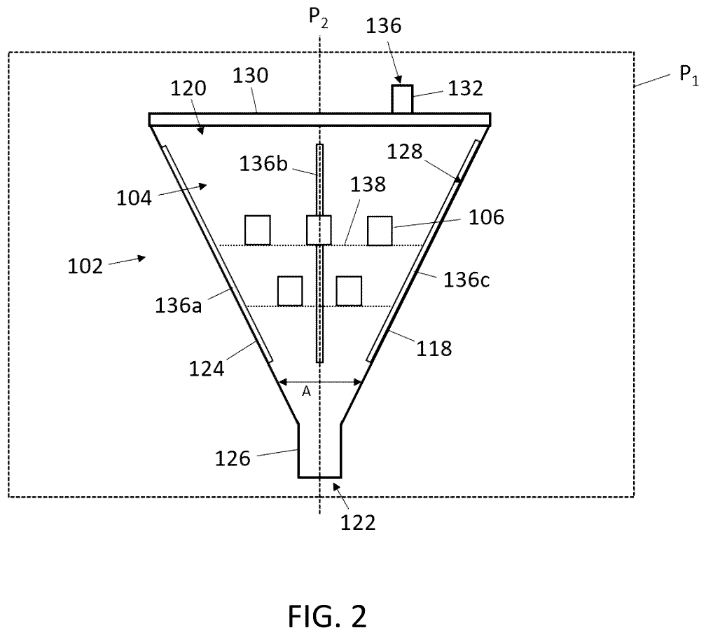

As shown in FIG. 2, the upper receptacle 102 comprises a main body 118 that surrounds a horizontal periphery of the upper cavity 104 (i.e., a periphery of the upper cavity 104 along a horizonal plane). The main body 118 defines an upper opening 120 for providing access to the upper cavity 104, such that the cannabinoid instruments 106 can be inserted into the upper cavity 104 via the upper opening 120. Moreover, the main body 118 defines a lower opening 122 for providing fluid communication between the upper and lower cavities.

In the present embodiment, the main body 118 of the upper receptacle 102 comprises a tapered portion 124 that defines the upper opening 120, and a cylindrical portion 126 that extends downward from the tapered portion 124 and defines the lower opening 122. The tapered portion 124 has an inner horizontal area A that gradually decreases in a downward direction toward the lower opening 122. In particular, the tapered portion 124 comprises an inner surface 128 that is substantially frustoconical, and the inner horizontal area A corresponds to the area delimited by the inner surface 128, as measured in a horizontal plane. Moreover, the inner surface 128 is inclined (i.e., sloped relative to vertical and horizontal) towards the lower opening 122. This incline of the inner surface 128 and the gradual reduction of its inner horizontal area can help collect and guide condensate toward the lower opening, similar to a funnel.

Although the main body 118 in the present embodiment comprises both the tapered portion 124 and the cylindrical portion 126, the main body 118 may comprise only the tapered portion 124 in some examples, such that the entire main body 118 is tapered. Moreover, similar funneling effects may be achieved by other shapes and configurations. For instance, the main body 118 may comprise a pyramidal shape or a V-shaped trough in some embodiments. Still further, the main body 118 may comprise other, non-funneling shapes (e.g., cylindrical, rectangular, etc.) without departing from the scope of the disclosure. Broadly speaking, the main body 118 can comprise any shape that surrounds a horizontal periphery of the upper cavity 104 and defines openings for access to and/or fluid communication with the upper cavity 104.

The upper receptacle 102 further comprises a door 130 for selectively closing the upper opening 120 of the main body 118. In particular, the door 130 is movably coupled to the main body 118 (e.g., via a hinge) such that the door 130 is movable between an open position (see FIG. 1) that enables access to the upper cavity 104 via the upper opening 120, and a closed position (see FIG. 2) that closes the upper opening 120. Moreover, the upper receptacle 102 further includes an exhaust pipe 132 that is affixed to and extends from the door 130 and defines an exhaust opening 136. When the door 130 is in the closed position, the exhaust opening 136 will be in fluid communication with the upper cavity 104 via an aperture in the door 130. Thus, although the door 130 is intended to close the upper opening 120 and inhibit the escape of vapors and heat within the upper receptacle 102, the exhaust pipe 132 can permit some vapors to be released into the ambient atmosphere to prevent the upper cavity 104 from over pressurization. However, the exhaust pipe 132 is optional, and may extend from the main body 118 in other examples.

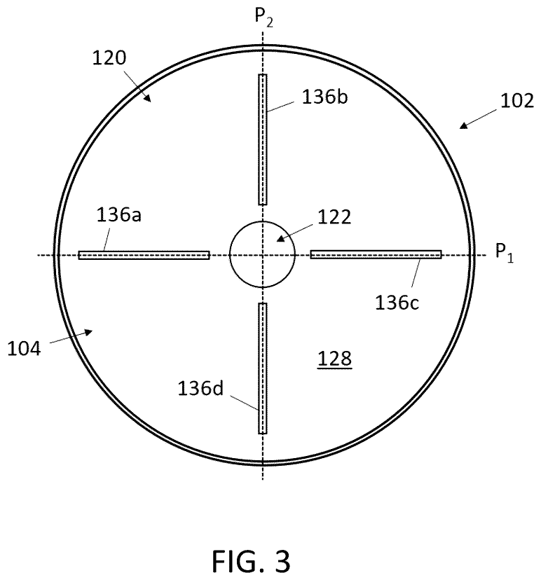

As shown in FIGS. 2 and 3, the upper receptacle 102 further includes a plurality of ribs 136a-d provided on the inner surface 128 that each extend longitudinally from an upper portion of the inner surface 128 to a lower portion of the inner surface 128. The ribs 136a-d are circumferentially and symmetrically spaced about the inner surface, such that the ribs 136a, 136c extend longitudinally along a first vertical plane P1, and the ribs 136b, 136d extend longitudinally along a second vertical plane P2 that is perpendicular to the first vertical plane P1. Each rib 136a-d can be a wire, bead, or other elongated body that is affixed to the inner surface 128 (e.g., via welding or fasteners). Alternatively, each rib 136a-d can be integrally formed with the inner surface 128.

In some examples, the cleaning apparatus 100 can include one or more racks 138 (see FIG. 2) for supporting cannabinoid instruments 106 within the upper cavity 104. Each rack 138 can comprise a substantially planar body that allows vapors and condensate to pass therethrough. For instance, each rack 138 can comprise a wire rack, a mesh screen, or a plate-like body defining a plurality of apertures. Furthermore, an outer perimeter of each rack 138 can comprise a shape that substantially conforms to the inner surface 128 of the main body 118. For example, as discussed above, the inner surface 128 in the present embodiment is substantially frustoconical, meaning that the inner surface 128 is substantially circular at horizontal cross-sections thereof. The outer perimeter of each rack 138 can also be substantially circular. Accordingly, each rack 138 can be placed within the upper cavity 104 and lowered an appropriate distance until its outer perimeter rests on the ribs 136a-d, as shown in FIG. 2. As mounted, the circular outer perimeter of each rack 138 will extend along and be slightly spaced from the inner surface 128, thereby permitting vapors and condensate to pass between the outer perimeter and inner surface 128. Moreover, because the ribs 136a-d extend longitudinally along the substantially frustoconical inner surface 128, they can accommodate racks 138 of different diameters by simply varying the height in which each rack 138 is placed within the upper cavity 104 and rests on the ribs 136a-d.

However, it is to be appreciated that the instruments 106 can be supported directly by the ribs 136a-d and/or inner surface 128 of the upper receptacle 102 without using any rack 138. Moreover, if an instrument 106 (e.g., pot, pan, etc.) has a substantially circular profile, it may be similarly placed within the upper cavity 104 and lowered an appropriate distance until its outer perimeter rests on the ribs 136a-d, thereby providing a space between the outer perimeter and inner surface 128 that allows vapors and condensate to pass therethrough.

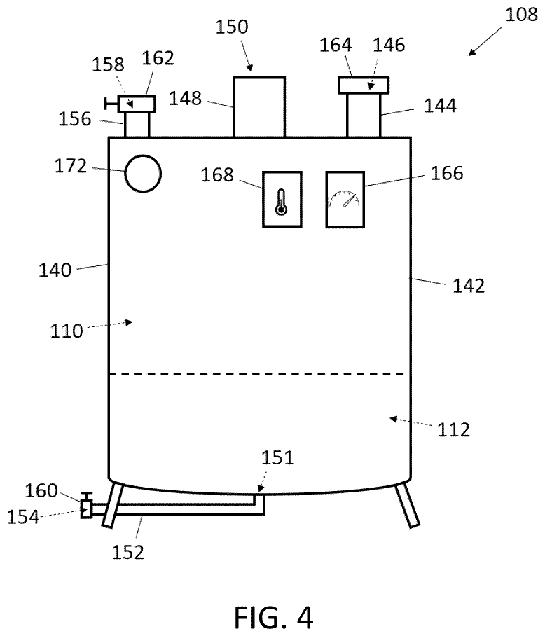

Turning to FIG. 4, the lower receptacle 108 comprises a main body 140 that defines the lower cavity 110 along with various inlet and outlet openings for the lower cavity 110. In particular, the main body 140 comprises a main section 142 that defines the lower cavity 110, an inlet pipe section 144 that extends from the main section 142 and defines an inlet opening 146 for supplying cleaning liquid 112 to the lower cavity 110, and an outlet pipe section 148 that extends from the main section 142 and defines an outlet opening 150 for establishing fluid communication between the upper and lower receptacles 102, 108. The main body 140 further includes a drain-pipe inlet 151 formed as an opening in the main section 142, a drain-pipe section 152 that extends from the main section 142 and defines a drain outlet 154 for draining liquid from the lower cavity 110, and an exhaust pipe section 156 that extends from the main section 142 and defines an exhaust outlet 158 for relieving excess pressure within the lower cavity 110. Preferably, the drain-pipe inlet 151 is located at or approximate to a lower-most portion of the lower cavity 110 to help facilitate the drainage of liquid from the lower cavity 110. For example, the lower end of the main section 142 in the present embodiment is bowl shaped, and the drain-pipe inlet 151 is positioned at the lower-most point of the main section 142.

Furthermore, the lower receptacle 108 can comprise one or more adjustable closing mechanisms (e.g., cap, valve, etc.) for selectively establishing fluid communication between the ambient atmosphere and the openings of the pipe sections described above. For example, the lower receptacle 108 in the present embodiment includes a drain valve 160 that is fluidly coupled to the drain-pipe section 152, an exhaust valve 162 that is fluidly coupled to the exhaust pipe section 156, and a cap 164 that removably covers the inlet opening 146 of the inlet pipe section 144. The drain valve 160 is operable between open and closed positions to selectively establish fluid communication between the ambient atmosphere and the drain outlet 154, while the exhaust valve 162 is operable between open and closed positions to selectively establish fluid communication between the ambient atmosphere and the exhaust outlet 158. Moreover, the cap 164 can be removably attached to the inlet pipe section 144 to selectively establish fluid communication between the ambient atmosphere and the inlet opening 146.

Additionally, the lower receptacle 108 may include various components that aid in monitoring and/or regulating the conditions inside of the lower cavity 110. For instance, the lower receptacle 108 in the present embodiment comprises a pressure gauge 166 affixed to the main body 140 that is configured to measure pressure within the lower cavity 110 and indicate the measured pressure on a display visible from the outside of the main body 140. Further, the lower receptacle 108 comprises a temperature gauge 168 affixed to the main body 140 that is configured to measure temperature within the lower cavity 110 and indicate the measured temperature on a display that is also visible from the outside of the main body 140. Still further, the lower receptacle 108 comprises a sight glass 172 that is affixed to the main body 140 and enables a user to view in lower cavity 110. The sight glass 172 may comprise, for example, a glass window with a gasket assembly welded or bolted into a wall of the main body 140.

As shown in FIG. 1, the lower receptacle 108 is arranged below the upper receptacle 102. Moreover, the cylindrical portion 126 of the upper receptacle 102 is affixed (e.g., welded) directly to the outlet pipe section 148 of the lower receptacle 108 to establish fluid communication between the upper and lower cavities 104, 110 (via the lower opening 122 of the cylindrical portion 126 and the outlet opening 150 of the outlet pipe section 148). However, in other examples, an intermediate member (e.g., pipe) can be provided between the upper and lower receptacles 102, 108 to establish fluid communication via the intermediate member.

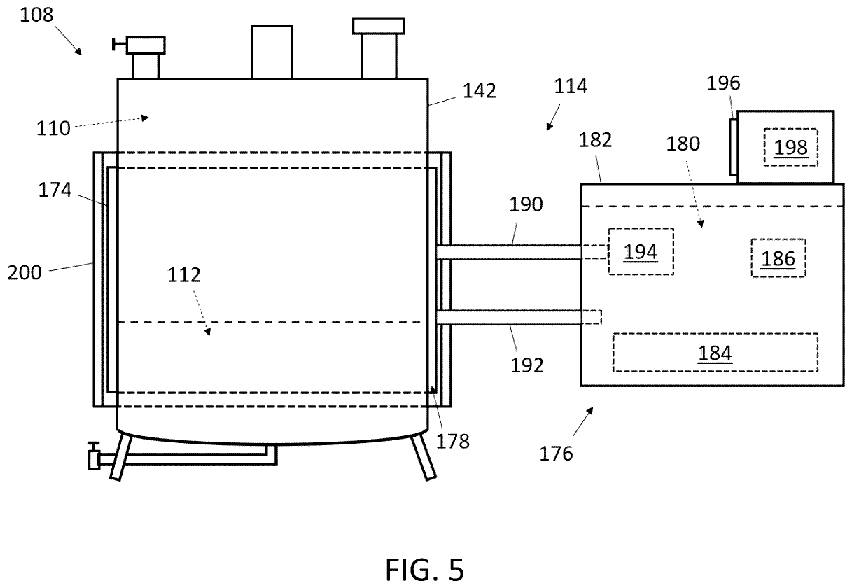

Turning to FIG. 5, the heating system 114 includes a heating jacket 174 that at least partially surrounds and is in thermal contact with the main section 142 of the lower receptacle 108. For the purposes of this disclosure, thermal contact can mean the heating jacket 174 is in direct contact with the lower receptacle 108, or is in thermal contact with the lower receptacle 108 via one or more thermally conductive bodies. In the present embodiment, the heating jacket 174 is a sleeve-shaped body that completely surrounds and is in direct contact with a horizontal periphery of the main section 142. The heating jacket 174 in the present embodiment spans a majority of the main section's vertical length, although it may span smaller or greater portions without departing from the scope of the disclosure. For example, in some embodiments, the heating jacket 174 may span the entire vertical length of the main section 142 from its lower-most end to its upper-most end.

The heating system 114 further includes a heating unit 176 that is operable to supply an interior 178 of the heating jacket 174 with a heating liquid 180. More specifically, the heating unit 176 comprises a heating compartment 182 for containing the heating liquid 180, a heating element 184 (i.e., gas burner, electric-resistive heating element, etc.) that is operable to heat the heating liquid 180 within the heating compartment 182, and a temperature sensor 186 that is operable to detect a temperature of the heating liquid 180. Moreover, the heating unit 176 includes a supply line 190 and return line 192 for establishing fluid communication between the heating jacket 174 and heating compartment 182. Each line 190, 192 can comprise any configuration of one or more fluid elements (e.g., pipe, tube, fluid coupling, etc.) that can convey fluid therethrough. Lastly, the heating unit 176 includes a pump 194 within the compartment 182 that is operable to convey the heating liquid 180 through the heating system 114. In particular, operation of the pump 194 will convey the heating liquid 180 within the heating compartment 182 through the supply line 190 and into the heating jacket 174. The heating liquid 180 will then convey through the interior 178 of the heating jacket 174 and be discharged through the return line 192 back into the heating compartment 182.

The heating unit 176 further includes a user interface 196 that is operatively coupled to a controller 198, which in turn is operatively coupled to the heating element 184, pump 194, and temperature sensor 186. The user interface 196 can include one or more input elements (e.g., touchscreen, buttons, switches, etc.) that enable a user to provide inputs to the controller 198 for operating the heating element 184 and/or pump 194. Moreover, user interface 196 can include one or more output elements (e.g., display, speaker, indicator lights, etc.) for conveying information related to operation of the heating unit 176, such as a temperature measured by the temperature sensor 186. In this manner, a user can monitor and control the operation of the heating system 114. For example, a user can input a desired temperature on the user interface 196 followed by a start command, upon which the controller 198 will execute an operation that continuously operates the pump 194 and regulates operation of the heating element 184 using feedback from the temperature sensor 186 to maintain the heating liquid 180 about the desired temperature.

Preferably, the heating liquid 180 has a boiling temperature that is higher than a boiling temperature of the cleaning liquid 112, such that the heating liquid 180 (and heating jacket 174 heated thereby) can be heated to a temperature that is sufficient to vaporize the cleaning liquid 112 while still maintaining the heating liquid 180 in its liquid state for conveyance through the heating system 114. For instance, the cleaning liquid 112 in the present example comprises alcohol, which has a boiling point of about 173.1° F. Accordingly, the heating liquid 180 can comprise propylene glycol, which has a boiling point of about 370.8° F. However, other heating liquids (e.g., glycerine, ethylene glycol, vegetable oil, canola oil, siloxanes, etc.) may be utilized in other examples without departing from the scope of the disclosure.

Lastly, in some examples, the heating system 114 can include an insulating jacket 200 that at least partially surrounds the heating jacket 174 and comprises an insulating material (e.g., silicone or polyester textile material) to help contain heat and within the insulating jacket 200 and shield users from the heating jacket 174. In the present example, the insulating jacket 200 comprises a sleeve-shaped body of polyester textile material that completely surrounds a horizontal periphery of the jacket 174. In preferred embodiments, the insulating jacket 200 spans an entire vertical length of the heating jacket 174. Additionally, the insulating jacket 200 may extend the entire vertical length of the main section 142 or further still, beyond the vertical length of the main section 142 to enclose a portion of the drain-pipe section 152.

However, the heating system 114 may comprise a variety of other configurations without departing from the scope of the disclosure. For example, the heating system 114 may simply comprise a heating element (e.g., gas burner, electrical-resistive heating element, etc.) that is operable to supply heat to or within the lower receptacle 108. Broadly speaking, the heating system 114 can comprise any configuration of one or more components that is/are operable to heat the cleaning liquid 112 within the lower receptacle 108.

An example method of cleaning the cannabinoid instruments 106 using the cleaning apparatus 100 will now be described. It should be understood that variations of certain steps may be suitable and that some steps described may be omitted and additional steps may be added. Additionally, the shown steps may be performed in different orders than the exemplary method described.

In the example method, the cleaning liquid 112 is supplied to the lower cavity 110 of the lower receptacle 108 via the inlet opening 146. Moreover, the cannabinoid instruments 106 are placed in the upper cavity 104 of the upper receptacle 102 via the upper opening 120, and supported by the racks 138 within the upper cavity 104 The heating system 114 can then be operated to vaporize an amount (i.e., all or some) of the cleaning liquid 112 within the lower cavity 110 such that the amount transforms to a cleaning vapor.

More specifically, a user can input a desired temperature on the user interface 196 for the heating liquid 180. It is preferable that the heating liquid 180 is heated to a temperature that is sufficient to vaporize the cleaning liquid 112 but is lower than a boiling point of the heating liquid 180 such that it maintains a liquid state for conveyance through the heating system 114. As discussed above, the cleaning liquid 112 in the present example comprises alcohol, which has a boiling point of about 173.1° F. Moreover, the heating liquid 180 comprises propylene glycol, which has a boiling point of about 370.8° F. Accordingly, the desired temperature for the heating liquid 180 can be from about 180° F. to about 220° F., and more preferably from about 190° F. to about 210° F. In the present embodiment, the desired temperature is about 198° F.

The user can then enter a start command on the user interface 196, upon which the controller 198 will execute an operation that continuously operates the pump 194 and regulates operation of the heating element 184 using feedback from the temperature sensor 186 to maintain the heating liquid 180 about the desired temperature. Operation of the pump 194 will cause the heating liquid 180 to circulate through the heating system 114, thereby supplying heat to the heating jacket 174 as it conveys therethrough. Moreover, the heating jacket 174 will in turn supply heat to the cleaning liquid 112 within the lower receptacle 108, such that an amount of the cleaning liquid 112 transforms to a cleaning vapor.

The cleaning vapor will then rise into the upper cavity 104 of the upper receptacle 102 (via the outlet opening 150 of the lower receptacle 108 and the lower opening 122 of the upper receptacle 102). The cleaning vapor will increase the temperature of cannabinoid matter on the instruments 106, thus reducing its viscosity and increasing its miscibility. Moreover, the cleaning vapor will eventually condense within the upper cavity 104 and form a cleaning condensate on the surfaces the instruments 106 that mixes with the cannabinoid matter, thereby forming a cannabinoid condensate that is a mixture of the cleaning condensate and cannabinoid matter.

The cannabinoid condensate will then drip from the instruments 106 and fall into the lower cavity 110 of the lower receptacle 108 (via the outlet opening 150 of the lower receptacle 108 and the lower opening 122 of the upper receptacle 102). As discussed above, the tapered portion 124 of the upper receptacle 102 has an inner horizontal area A that gradually decreases in a downward direction toward the lower opening 122. Moreover, the inner surface 128 of the upper receptacle 102 is inclined towards the lower opening 122. This incline of the inner surface 128 and the gradual reduction of its inner horizontal area can help collect and guide the cannabinoid condensate toward and through the lower opening 122, similar to a funnel.

As the cannabinoid condensate falls into the lower cavity 110, it will mix with residual cleaning liquid 112 in the lower cavity 110 and/or any additional condensate in the lower cavity 110 to form a final solution (the additional condensate can be condensate that previously fell into the lower cavity 110, or subsequent condensate that falls into the lower cavity 110 after the cannabinoid condensate). Thus, the final solution will correspond to a mixture of cannabinoid matter and the residual and/or condensed cleaning liquid 112. The final solution can then be discharged from the lower receptacle 108 by opening the drain valve 160, thereby discharging the final solution via the drain outlet 154. Moreover, the final solution can then be distilled using convention distilling apparatus and methods to extract cannabis distillate from the final solution.

In this manner, the apparatus 100 and method described above can efficiently clean the instruments 106 by removing cannabinoid matter adhered to their surfaces. Moreover, the cannabinoid matter is not wasted, but rather forms a final solution that can be distilled to produce cannabis distillate.

The invention has been described with reference to the example embodiments described above. While various features are presented above, it should be understood that the features may be used individually or in any combination thereof. Further, it should be understood that variations and modifications may occur to those skilled in the art upon a reading and understanding of this specification. Example embodiments incorporating one or more aspects of the invention are intended to include all such modifications and alterations insofar as they come within the scope of the appended claims.

What is claimed is:

1. A cleaning apparatus for a cannabinoid instrument, comprising:
a lower receptacle defining a lower cavity for receiving a cleaning liquid;
an upper receptacle arranged above the lower receptacle and defining an upper cavity for receiving the cannabinoid instrument, the upper cavity being in fluid communication with the lower cavity; and
a heating system configured for vaporizing an amount of the cleaning liquid when the cleaning liquid is received in the lower cavity of the lower receptacle, such that the amount transforms to a cleaning vapor that rises into the upper cavity of the upper receptacle.

2. The cleaning apparatus of claim 1, wherein the upper cavity comprises a tapered portion having a horizontal inner area that gradually decreases in a downward direction.

3. The cleaning apparatus of claim 2, wherein the tapered portion of the upper cavity has an inner surface that is substantially frustoconical.

4. The cleaning apparatus of claim 1, further comprising an exhaust pipe affixed to and extending from the upper receptacle, the exhaust pipe providing fluid communication between the upper cavity and an ambient atmosphere of the cleaning apparatus.

5. The cleaning apparatus of claim 1, wherein the heating system comprises a heating jacket extending at least partially around the lower receptacle in thermal contact therewith, the heating jacket being configured to receive a heating liquid therein.

6. The cleaning apparatus of claim 5, further comprising an insulating layer extending at least partially around the heating jacket.

7. The cleaning apparatus of claim 5, wherein the heating system further comprises:
a heating compartment for containing the heating liquid,
a heating element that is operable to heat the heating liquid when contained within the heating compartment,
a supply line configured for conveying the heating liquid from the heating compartment to the heating jacket, and
a return line configured for conveying the heating liquid from the heating jacket to the heating compartment.

8. The cleaning apparatus of claim 1, further comprising a wire rack in the upper cavity of the upper receptacle, the wire rack configured for supporting the cannabinoid instrument.

9. The cleaning apparatus of claim 1, further comprising a pressure gauge configured to measure a pressure of the lower cavity and display the measured pressure.

10. The cleaning apparatus of claim 1, wherein the upper receptacle comprises:
a main body that surrounds a horizontal periphery of the upper cavity, the main body defining an opening for providing access to the upper cavity, and
a door movably coupled to the main body for selectively closing the opening.

11. The cleaning apparatus of claim 1, wherein the upper receptacle comprises:
a main body that extends around a horizontal periphery of the upper cavity, and
a rib provided on an inner surface of the main body.

12. The cleaning apparatus of claim 10, wherein the rib extends longitudinally along a vertical plane.

13. The cleaning apparatus of claim 1, wherein the lower receptacle comprises:
a main section defining the lower cavity,
a drain pipe affixed to and extending from the main section, and
a valve that is operable to provide selective communication between an outlet of the drain pipe and an ambient atmosphere of the cleaning apparatus.

14. A cleaning method using the cleaning apparatus of claim 1, the cleaning method comprising:
providing the cleaning liquid in the lower cavity of the lower receptacle;
placing the cannabinoid instrument within the upper cavity of the upper receptacle; and
operating the heating system to vaporize the amount of the cleaning liquid in the lower cavity such that the amount transforms to the cleaning vapor,
wherein the cleaning vapor rises into the upper cavity and condenses in the upper cavity to form a cleaning condensate that mixes with cannabinoid matter on the cannabinoid instrument to form a cannabinoid condensate that falls into the lower cavity of the lower receptacle.

15. The cleaning method of claim 14, wherein the cannabinoid condensate combines with residual cleaning liquid and/or additional condensate in the lower cavity to form a final solution.

16. The cleaning method of claim 15, further comprising distilling the final solution to extract cannabis distillate from the final solution.

17. The cleaning method of claim 14, wherein:
the heating system comprises a heating jacket that at least partially surrounds the lower receptacle and is in thermal contact therewith, the heating jacket being configured to receive a heating liquid, and
operating the heating system comprises supplying the heating liquid to the heating jacket.

18. The cleaning method of claim 17, wherein operating the heating system comprises heating the heating liquid to a temperature from about 180° F. to about 220° F.

19. The cleaning method of claim 16, wherein the heating liquid comprises propylene glycol.

20. The cleaning method of claim 13, wherein the cleaning liquid comprises alcohol.
